(19) United States
(12) Patent Application Publication
(10) Pub. No.: US 2026/0158849 A1
(43) Pub. Date: Jun. 11, 2026

(54) HEAT PUMP SYSTEM FOR A VEHICLE

(71) Applicants: HYUNDAI MOTOR COMPANY, Seoul (KR); KIA CORPORATION, Seoul (KR)

(72) Inventors: Hoyoung Jeong, Hwaseong-si (KR); Yong Woong Cha, Hwaseong-si (KR); Hochan An, Hwaseong-si (KR); Joongsu Yun, Hwaseong-si (KR); Jungha Park, Hwaseong-si (KR); Jeawan Kim, Hwaseong-si (KR); Gwi Taek Kim, Hwaseong-si (KR); Man Hee Park, Hwaseong-si (KR); Yeong Jun Kim, Hwaseong-si (KR); Jae Yeon Kim, Hwaseong-si (KR); Yeon Ho Kim, Hwaseong-si (KR)

(73) Assignees: HYUNDAI MOTOR COMPANY, Seoul (KR); KIA CORPORATION, Seoul (KR)

(21) Appl. No.: 19/258,553

(22) Filed: Jul. 2, 2025

(30) Foreign Application Priority Data
Dec. 6, 2024 (KR) 10-2024-0180995

(51) Int. Cl. B60H 1/00; B60H 1/14; F25B 30/02; F25B 41/31; F25B 43/00

(52) U.S. Cl. CPC B60H 1/00278; B60H 1/00485; B60H 1/143; F25B 30/02; F25B 41/31; F25B 43/006

(57) ABSTRACT

A heat pump system for a vehicle is capable of performing cooling or heating of a vehicle interior by using a natural refrigerant in compliance with environmental regulations, and by efficiently adjusting the temperature of the battery module by using a single chiller where a refrigerant and a coolant exchange heat with each other.

### CROSS-REFERENCE TO RELATED APPLICATION

This application claims priority to and the benefit of Korean Patent Application No. 10-2024-0180995, filed with the Korean Intellectual Property Office on Dec. 6, 2024, the entire contents of which is incorporated herein by reference.

### FIELD

The present disclosure relates to a heat pump system for a vehicle, and more particularly, the present disclosure relates to a heat pump system for a vehicle capable of performing cooling or heating of a vehicle.

### BACKGROUND

An air conditioning system for a vehicle includes an air conditioner unit circulating a refrigerant in order to heat or cool an interior of the vehicle.

The air conditioner unit, which maintains the interior of the vehicle at an appropriate temperature regardless of a change in an external temperature to maintain a comfortable interior environment, is configured to heat or cool the interior of the vehicle by heat-exchange by a condenser and an evaporator in a process in which a refrigerant discharged by driving of a compressor is circulated back to the compressor through the condenser, a receiver drier, an expansion valve, and the evaporator.

In other words, the air conditioner unit lowers a temperature and a humidity of the interior by condensing a high-temperature high-pressure gas-phase refrigerant compressed from the compressor by the condenser, passing the refrigerant through the receiver drier and the expansion valve, and then evaporating the refrigerant in the evaporator in a cooling mode in the summer.

An environment-friendly technology of a vehicle is a core technology of a future automobile industry, and advanced car makers have focused their energy on the development of an environmentally-friendly vehicle to achieve environmental and fuel efficiency regulations.

In accordance with a continuous increase in interest in energy efficiency and an environmental pollution problem, the development of an environmentally-friendly vehicle capable of substantially substituting for an internal combustion engine vehicle is required, and the environmentally-friendly vehicle is classified into an electric vehicle driven using a fuel cell or electricity as a power source and a hybrid vehicle driven using an engine and a battery.

The electric vehicle is in spotlight as a means of transportation in the future to solve environment problems and energy resource problems.

A heat pump system, which is an air conditioner apparatus for regulating the temperature of the vehicle interior, is applied to such an electric vehicle.

However, the refrigerant that is conventionally used in the heat pump system contains a large amount of environmentally regulated material, e.g., PFAS (Per- and Polyfluoroalkyl Substances), and therefore, there is a demand for the development of a system capable of controlling the temperature of the vehicle interior by using new refrigerants without PFAS and flammability, or natural refrigerants.

The above information disclosed in this Background section is only to enhance understanding of the background of the disclosure, and therefore it may contain information that does not form the prior art that is already known to one having ordinary skill in the art.

### SUMMARY

The present disclosure provides a heat pump system for a vehicle capable of performing cooling or heating of a vehicle interior by using a natural refrigerant in compliance with environmental regulations, and by efficiently adjusting the temperature of the battery module by using a single chiller where a refrigerant and a coolant heat-exchange each other.

In addition, the present disclosure provides a heat pump system for a vehicle capable of maximizing the cooling and heating performance by operating in both a supercritical region and a subcritical region in which the pressure and/or temperature of the refrigerant is higher than a critical pressure and/or temperature, by applying R744 refrigerant, which is a natural refrigerant utilizing carbon dioxide.

A heat pump system for a vehicle includes a compressor, a first heat-exchanger, a second heat-exchanger, a first expansion valve, and a third heat-exchanger, which are connected through the refrigerant line to circulate the refrigerant. The heat pump system further includes a chiller connected to the refrigerant line through a first connection line, and configured to adjust a temperature of the coolant by heat-exchanging the supplied refrigerant with a coolant. The heat pump system further includes a second expansion valve provided on the first connection line, and a third expansion valve provided on the refrigerant line between the third heat-exchanger and the compressor. The heat pump system further includes a second connection line having a first end connected to the refrigerant line between the first heat-exchanger and the second heat-exchanger, and a second end connected to the refrigerant line between the second heat-exchanger and the third heat-exchanger. The heat pump system further includes a fourth expansion valve provided on the second connection line. The heat pump system further includes a third connection line having a first end connected to the refrigerant line between the compressor and the first heat-exchanger, and a second end connected to the refrigerant line between the first heat-exchanger and the second heat-exchanger. The heat pump system further includes a fourth connection line having a first end connected to the refrigerant line between the second heat-exchanger and the third heat-exchanger, and a second end connected to the refrigerant line between the third heat-exchanger and the third expansion valve.

The heat pump system may further include a first valve provided on the refrigerant line between the first heat-exchanger and the second heat-exchanger, a second valve provided on the refrigerant line between the third expansion valve and the compressor, a third valve provided on the third connection line, and a fifth expansion valve provided on the fourth connection line.

The heat pump system may further include a fifth connection line having a first end connected to the refrigerant line between the third expansion valve and the compressor, and a second end connected to the refrigerant line between the first heat-exchanger and the second heat-exchanger, a fourth valve provided on the fifth connection line, a sixth connection line having a first end connected to the first connection line between the second expansion valve and the chiller, and a second end connected to the third connection line, and a sixth expansion valve provided on the sixth connection line.

The heat pump system may further include an accumulator provided on the refrigerant line between the third heat-exchanger and the compressor. The heat pump system may further include an internal heat-exchanger provided inside the accumulator, and configured to heat-exchange the refrigerant supplied from the second heat-exchanger, and the refrigerant supplied from the third heat-exchanger, with each other, and to supply the refrigerant having a higher temperature among the heat-exchanged refrigerant to the third heat-exchanger.

When a battery module is to be heated, a portion of the refrigerant line connecting the compressor and the first heat-exchanger, and a portion of the refrigerant line connecting the first heat-exchanger and the second heat-exchanger may be closed by the first valve. A portion of the refrigerant line connecting a first end of the fifth connection line and the compressor may be opened. A portion of the refrigerant line connected to the second heat-exchanger may be opened so that a first end of the fourth connection line and a second end of the fifth connection line are connected. A portion of the refrigerant line connecting a second end of the first connection line and a second end of the fourth connection line may be opened by the third expansion valve. A portion of the refrigerant line connecting the second end of the first connection line and the first end of the fifth connection line may be closed by the second valve. A portion of the first connection line connecting a first end of the sixth connection line and the chiller may be opened. A remaining portion of the first connection line connecting the refrigerant line and the sixth connection line at an upstream end of the chiller may be closed by the second expansion valve. The second connection line may be closed by the fourth expansion valve. A portion of the third connection line may be opened so that a portion of the refrigerant line connected to the compressor and the sixth connection line are connected. A remaining portion of the third connection line may be closed by the third valve. The fourth connection line may be opened by the fifth expansion valve, the fifth connection line may be opened by the fourth valve, and the sixth connection line may be opened by the sixth expansion valve.

The third expansion valve and the sixth expansion valve may allow the introduced refrigerant to flow without expansion. The fifth expansion valve may allow the introduced refrigerant to flow in an expanded state. The refrigerant discharged from the compressor may be introduced into the chiller sequentially along a portion of the third connection line, the sixth connection line, and a portion of the first connection line. The refrigerant having passed through the chiller may be introduced into the second heat-exchanger along a portion of the first connection line. The fourth connection line and the opened portion of the refrigerant lines, and the refrigerant discharged from the second heat-exchanger may pass through the internal heat-exchanger and the accumulator along a portion of the refrigerant lines and the fifth connection line, to be supplied to the compressor.

In a hot gas heating mode of a vehicle interior, a portion of the refrigerant line connecting a first end of the first connection line to a second end of the second connection line may be closed by the first expansion valve. A portion of the refrigerant line connecting a first end of the second connection line and a second end of the fifth connection line may be closed by the first valve. A portion of the refrigerant line connecting the second end of the second connection line to a second end of the first connection line by passing through the third heat-exchanger may be opened by the third expansion valve. A portion of the refrigerant line connecting the second end of the first connection line and a first end of the fifth connection line may be opened by the second valve. A portion of the refrigerant line connecting the second end of the fifth connection line to the first end of the first connection line via the second heat-exchanger may be closed. A portion of the first connection line connecting a first end of the sixth connection line and the chiller may be opened. A remaining portion of the first connection line connecting the refrigerant line and the sixth connection line on an upstream end of the chiller may be closed by the second expansion valve. The second connection line may be opened by the fourth expansion valve. A portion of the third connection line may be opened so that a portion of the refrigerant line connected to the compressor and the sixth connection line are connected. A remaining portion of the third connection line may be closed by the third valve. The fourth connection line may be closed by the fifth expansion valve, the fifth connection line may be closed by the fourth valve, and the sixth connection line may be opened by the sixth expansion valve.

The third expansion valve and the sixth expansion valve may allow the introduced refrigerant to flow in an expanded state. The fourth expansion valve may allow the introduced refrigerant to flow without expansion. A partial refrigerant among the refrigerant discharged from the compressor may be introduced into the first heat-exchanger along the refrigerant line. The refrigerant having passed through the first heat-exchanger may be introduced into the third heat-exchanger along the second connection line and the opened refrigerant line. A remaining refrigerant among the refrigerant discharged from the compressor may be introduced into the chiller along a portion of the third connection line, the sixth connection line, and the opened first connection line. The refrigerant having passed through the third expansion valve from the third heat-exchanger, and the refrigerant discharged from the chiller may pass through the internal heat-exchanger and the accumulator along a portion of the refrigerant line, to be supplied to the compressor.

In a heating mode of a vehicle interior, a portion of the refrigerant line connecting a first end of the first connection line to a second end of the second connection line may be closed by the first expansion valve. A portion of the refrigerant line connecting a first end of the second connection line and a second end of the fifth connection line may be closed by the first valve. A portion of the refrigerant line connecting a second end of the fourth connection line and a second end of the first connection line may be closed by the third expansion valve. A portion of the refrigerant line connecting the second end of the first connection line and a first end of the fifth connection line may be opened by the second valve. The first connection line may be opened by the second expansion valve, the second connection line may be opened by the fourth expansion valve, the third connection line may be closed by the third valve, the fourth connection line may be opened by the fifth expansion valve, the fifth connection line may be opened by the fourth valve, and the sixth connection line may be closed by the sixth expansion valve.

The second expansion valve and the fourth expansion valve may allow the introduced refrigerant to flow without expansion. The fifth expansion valve may allow the refrigerant to flow in an expanded state so that the expanded refrigerant is supplied to the second heat-exchanger, the internal heat-exchanger, and the chiller. A partial refrigerant among the refrigerant introduced into the fourth connection line from the third heat-exchanger may be introduced into the second heat-exchanger, and a remaining refrigerant among the refrigerant introduced into the fourth connection line from the third heat-exchanger may be introduced into the internal heat-exchanger.

A partial refrigerant among the refrigerant discharged from the fifth expansion valve may pass through the internal heat-exchanger along the refrigerant line, to be introduced into the chiller, and the refrigerant discharged from the second heat-exchanger and the chiller may pass through the internal heat-exchanger and the accumulator, to be supplied to the compressor.

When heating of a battery module is required in a heating mode of a vehicle interior, a portion of the refrigerant line connecting a first end of the first connection line to a second end of the second connection line, and a portion of the refrigerant line connecting a first end of the fourth connection line to the first end of the first connection line may be closed by the first expansion valve. A portion of the refrigerant line connecting a first end of the second connection line and a second end of the fifth connection line may be closed by the first valve. A portion of the refrigerant line connecting the second end of the second connection line to a second end of the first connection line by passing through the third heat-exchanger may be opened by the third expansion valve. A portion of the refrigerant line connecting the second end of the first connection line and a first end of the fifth connection line may be closed by the second valve. A portion of the refrigerant line connected to the second heat-exchanger may be opened so that the first end of the fourth connection line and the second end of the fifth connection line are connected. A portion of the first connection line connecting a first end of the sixth connection line and the chiller may be opened. A remaining portion of the first connection line connecting the refrigerant line and the sixth connection line on an upstream end of the chiller may be closed by the second expansion valve. The second connection line may be opened by the fourth expansion valve. A portion of the third connection line may be opened so that a portion of the refrigerant line connected to the compressor and the sixth connection line are connected. A remaining portion of the third connection line may be closed by the third valve, the fourth connection line may be opened by the fifth expansion valve, the fifth connection line may be opened by the fourth valve, and the sixth connection line may be opened by the sixth expansion valve.

The third expansion valve, the fourth expansion valve, and the sixth expansion valve may allow the introduced refrigerant to flow without expansion. The fifth expansion valve may allow the introduced refrigerant to flow in an expanded state. A partial refrigerant among the refrigerant discharged from the compressor may be introduced into the first heat-exchanger along the refrigerant line. The refrigerant having passed through the first heat-exchanger may be introduced into the third heat-exchanger along the second connection line and the opened refrigerant line. A remaining refrigerant among the refrigerant discharged from the compressor may be introduced into the chiller along a portion of the third connection line, the sixth connection line, and the opened first connection line, the refrigerant having passed through the third heat-exchanger, and the refrigerant having passed through the third expansion valve from the chiller may be introduced into the second heat-exchanger along a portion of the refrigerant line and the fourth connection line. The refrigerant discharged from the second heat-exchanger may pass through the internal heat-exchanger and the accumulator along the opened portion of the refrigerant lines and the fifth connection line, to be supplied to the compressor.

In a heating-and-dehumidifying mode of a vehicle interior, a portion of the refrigerant line connecting a first end of the first connection line and a second end of the second connection line may be closed by the first expansion valve. A portion of the refrigerant line connecting a first end of the second connection line and the second heat-exchanger may be closed by the first valve. A portion of the refrigerant line connecting the third heat-exchanger and the accumulator may be opened by the second valve and the third expansion valve. A portion of the refrigerant line connecting the second heat-exchanger to the internal heat-exchanger and the first end of the first connection line may be closed. The first connection line may be closed by the second expansion valve. The second connection line may be opened by the fourth expansion valve. The third connection line may be closed by the third valve. The fourth connection line may be closed by the fifth expansion valve. The fifth connection line may be closed by the fourth valve, and the sixth connection line may be closed by the sixth expansion valve.

The third expansion valve may allow the introduced refrigerant to flow without expansion. The fourth expansion valve may allow the refrigerant introduced through the second connection line from the first heat-exchanger to flow in an expanded state. The refrigerant discharged from the compressor may be introduced into the first heat-exchanger along a portion of the refrigerant line. The refrigerant having passed through the first heat-exchanger may be introduced into the third heat-exchanger along the second connection line and the opened refrigerant line. The refrigerant having passed through the third expansion valve from the third heat-exchanger may pass through the internal heat-exchanger and the accumulator along the opened portion of the refrigerant line, to be supplied to the compressor.

When cooling of a battery module is required in a cooling mode of a vehicle interior, a portion of the refrigerant line connecting the compressor and the first heat-exchanger, and a portion of the refrigerant line connecting the first heat-exchanger and the second heat-exchanger may be closed by the first valve. A portion of the refrigerant line connecting a second end of the third connection line to the second heat-exchanger may be opened. A portion of the refrigerant line connecting the second heat-exchanger to the third heat-exchanger may be opened by the first expansion valve. A portion of the refrigerant line connecting the third heat-exchanger to the compressor may be opened by the third expansion valve. A portion of the refrigerant line connecting a second end of the first connection line and a first end of the fifth connection line may be opened by the second valve. The first connection line may be opened by the second expansion valve, the second connection line may be closed by the fourth expansion valve, the third connection line may be opened by the third valve, the fourth connection line may be closed by the fifth expansion valve, the fifth connection line may be closed by the fourth valve, and the sixth connection line may be closed by the sixth expansion valve.

The first expansion valve may allow the introduced refrigerant to flow in an expanded state. The second expansion valve may allow the introduced refrigerant to flow in an expanded state so that the battery module is cooled by using the coolant heat-exchanged with the refrigerant in the chiller. The third expansion valve may allow the introduced refrigerant to flow without expansion. The refrigerant discharged from the compressor may pass through the second heat-exchanger along the third connection line and a portion of the refrigerant line, to be introduced into the internal heat-exchanger. A partial refrigerant among the refrigerant discharged from the internal heat-exchanger may be introduced into the chiller along the first connection line. A remaining refrigerant among the refrigerant discharged from the internal heat-exchanger may be introduced into the first expansion valve along the refrigerant line. The refrigerant discharged from the chiller, and the refrigerant discharged from the third heat-exchanger may pass through the internal heat-exchanger and the accumulator along the refrigerant line, to be supplied to the compressor.

The second heat-exchanger and the third heat-exchanger may be configured to cool or evaporate the interiorly introduced refrigerant.

A first end of the first connection line may be connected to the refrigerant line between the second heat-exchanger and the first expansion valve, and a second end of the first connection line may be connected to the refrigerant line between the third heat-exchanger and the compressor.

The first heat-exchanger, the second heat-exchanger, and the third heat-exchanger may be air-cooled gas coolers configured to heat-exchange the interiorly introduced refrigerant with an air, and the chiller is a water-cooled gas cooler configured to heat-exchange the interiorly introduced refrigerant with the coolant.

As described above, according to a heat pump system for a vehicle according to an embodiment of the present disclosure, cooling or heating of vehicle interior may be performed by using a natural refrigerant, thereby enabling compliance with environmental regulations, and improving the overall marketability of vehicle.

In addition, according to the present disclosure, by operating in both a supercritical region and a subcritical region in which the pressure and/or temperature of the refrigerant is higher than a critical pressure and/or temperature at the time of cooling and heating the vehicle interior, by applying R744 refrigerant, which is a natural refrigerant utilizing carbon dioxide, the cooling and heating performance can be maximized.

In addition, according to the present disclosure, by efficiently adjusting the temperature of the battery module depending on the mode of the vehicle by using a single chiller where the coolant and the refrigerant are heat-exchanged with each other, streamlining and simplification of the system may be achieved.

In addition, according to the present disclosure, by efficiently adjusting the temperature of the battery module, the optimal performance of the battery module may be obtained, and the overall travel distance of the vehicle may be increased through the efficient management of battery module.

In addition, according to the present disclosure, even if the external temperature is low, and the heat generated from the electrical components and the battery module is not sufficient, heating of the vehicle interior may be performed by using the high-temperature refrigerant compressed in the compressor.

In addition, according to the present disclosure, by heating the battery module by using the coolant heat increased through heat-exchange with the refrigerant, a separate coolant heater for heating the battery module may be removed, and the power consumption for increasing the temperature of the battery module can be minimized.

In addition, according to the present disclosure, through streamlining of an entire system, it is possible to reduce manufacturing cost and weight and improve space utilization.

### BRIEF DESCRIPTION OF THE DRAWINGS

FIG. 1 is a block diagram of a heat pump system for a vehicle according to an embodiment of the present disclosure.

FIG. 2 is an operation diagram of a heat pump system for a vehicle according to an embodiment of the present disclosure, for heating a battery module.

FIG. 3 is an operation diagram of a heat pump system for a vehicle according to an embodiment of the present disclosure, for a hot gas heating mode of the vehicle interior.

FIG. 4 is an operation diagram according to a heating mode of the vehicle interior in a heat pump system for a vehicle according to an embodiment of the present disclosure.

FIG. 5 is an operation diagram of a heat pump system for a vehicle according to an embodiment of the present disclosure, for heating the battery module in the heating mode of the vehicle interior.

FIG. 6 is an operation diagram according to a heating-and-dehumidifying mode of the vehicle interior in a heat pump system for a vehicle according to an embodiment of the present disclosure.

FIG. 7 is an operation diagram of a heat pump system for a vehicle according to an embodiment of the present disclosure, for cooling the battery module in the cooling mode of the vehicle interior.

### DETAILED DESCRIPTION

Embodiments of the present disclosure hereinafter are described in detail with reference to the accompanying drawings.

Embodiments of the present disclosure in the present specification and the constructions depicted in the drawings are only example embodiments of the present disclosure, and do not cover the entire scope of the present disclosure. Therefore, it should be understood that there may be various equivalents to and variations of the disclosed embodiments at a time that the technical concepts of this specification are applied.

In order to clarify the present disclosure, parts that are not related to the description may have been omitted. Further, the same elements or equivalents are referred to with the same reference numerals throughout the specification.

Also, the size and thickness of each element may be arbitrarily shown in the drawings, but the present disclosure is not necessarily limited thereto. In the drawings, the thickness of layers, films, panels, regions, and the like, may be exaggerated for clarity.

In addition, unless explicitly described to the contrary, the word “comprise”, “have”, “include”, and variations thereof such as “comprises” or “comprising”, should be understood to imply the inclusion of stated elements but not the exclusion of any other elements.

Furthermore, each of terms, such as “. . . unit”, “. . . means”, “. . . portions”, “. . . part”, and “. . . member” described in the specification, mean a unit of a comprehensive element that performs at least one function or operation. When a component, device, unit, module, controller, detector, element, or the like of the present disclosure is described as having a purpose or performing an operation, function, or the like, the component, device, unit, module, controller, detector, or element should be considered herein as being “configured to” meet that purpose or to perform that operation or function. The present disclosure describes a controller and a data detector for a cooling system. The controller, detector, or other such components may separately embody or be included with a processor and a memory, such as a non-transitory computer readable media, as part of the controller or component.

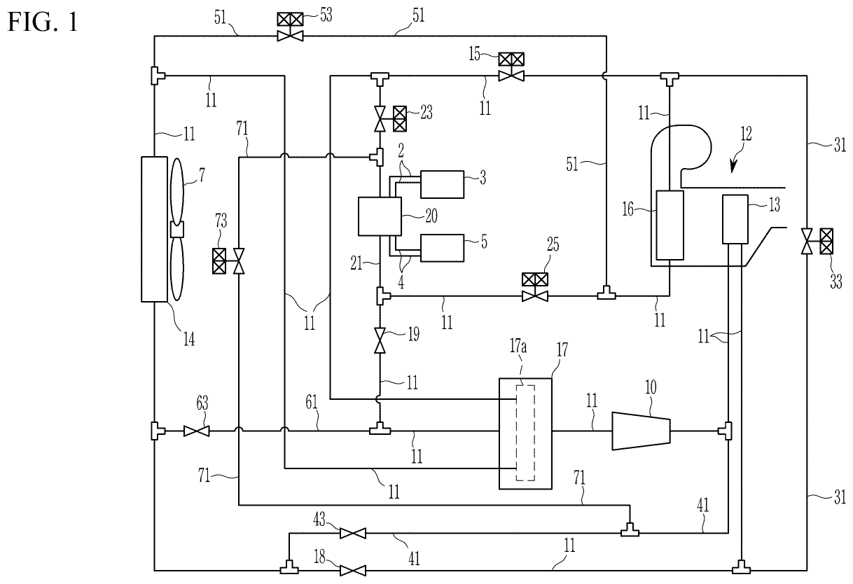

FIG. 1 is a block diagram of a heat pump system for a vehicle according to an embodiment of the present disclosure.

A heat pump system for a vehicle according to an embodiment of the present disclosure may perform cooling or heating of a vehicle interior by using a natural refrigerant in compliance with environmental regulations, and may efficiently adjust the temperature of a battery module 5 by using a single chiller 20 where the refrigerant and a coolant are heat-exchanged with each other.

The refrigerant may be an R744 refrigerant formed of carbon dioxide, which has an ozone depletion potential (ODP) of 0 and a global warming potential (GWP) of 1.

In other words, according to a heat pump system for a vehicle according to an embodiment of the present disclosure, by operating in both a supercritical region and a subcritical region in which the pressure and/or temperature of the refrigerant is higher than a critical pressure and/or temperature, by applying the R744 refrigerant, which is a natural refrigerant utilizing carbon dioxide, the cooling and heating performance can be maximized.

For such a purpose, a heat pump system according to an embodiment of the present disclosure may include a compressor 10, a first heat-exchanger 13, a second heat-exchanger 14, a first expansion valve 15, a third heat-exchanger 16, an accumulator 17, an internal heat-exchanger 17a, and the chiller 20, connected through the refrigerant line 11 to circulate the refrigerant through a refrigerant line 11.

The compressor 10 may compress the introduced refrigerant and allow the compressed refrigerant to flow through the refrigerant line 11 so that the refrigerant circulates along the refrigerant line 11.

The first heat-exchanger 13 may heat-exchange the refrigerant selectively supplied from the compressor 10 with the air.

The second heat-exchanger 14 may be connected to the first heat-exchanger 13 through the refrigerant line 11. Accordingly, the refrigerant supplied from the refrigerant line 11 may pass through the second heat-exchanger 14.

The second heat-exchanger 14 may be disposed at the front of the vehicle, and may cool or evaporate the refrigerant through heat-exchange with the air introduced from the outside while the vehicle is driving. A cooling fan 7 may be provided on a downstream side of the second heat-exchanger 14.

Since the R744 refrigerant does not have a phase change unlike the typical refrigerant, the term “gas cooling” may be used instead of the term “condensation”.

In an embodiment of the present disclosure, the first expansion valve 15 may be provided on the refrigerant line 11 between the second heat-exchanger 14 and the third heat-exchanger 16. The first expansion valve 15 may selectively expand the refrigerant introduced through the refrigerant line 11.

In other words, the first expansion valve 15 may selectively expand the refrigerant while controlling a flowing movement of the refrigerant.

In addition, the third heat-exchanger 16 may be provided on the refrigerant line 11 between the first expansion valve 15 and the compressor 10.

The first heat-exchanger 13 and the third heat-exchanger 16 may be provided inside a heating, ventilation, and air-conditioning (HVAC) module 12.

Accordingly, the third heat-exchanger 16 may cool or evaporate the refrigerant through heat-exchange with the air introduced into the HVAC module 12.

In other words, the first heat-exchanger 13, the second heat-exchanger 14, and the third heat-exchanger 16 may be an air-cooled gas cooler configured to heat-exchange the interiorly introduced refrigerant with the air.

The second heat-exchanger 14 and the third heat-exchanger 16 may evaporate the refrigerant when the expanded refrigerant is introduced, and may cool the refrigerant when the unexpanded refrigerant is introduced.

In an embodiment of the present disclosure, the accumulator 17 may be provided on the refrigerant line 11 between the third heat-exchanger 16 and the compressor 10.

The accumulator 17 may supply only the gaseous refrigerant to the compressor 10, thereby improving the efficiency and durability of the compressor 10.

In addition, the internal heat-exchanger 17a may be provided inside the accumulator 17. The internal heat-exchanger 17a may heat-exchange the refrigerant supplied from the second heat-exchanger 14, and the refrigerant supplied from the third heat-exchanger 16, with each other, and may supply the refrigerant having a higher temperature among the heat-exchanged refrigerants to the third heat-exchanger 16.

In other words, the internal heat-exchanger may heat-exchange the refrigerant cooled in the second heat-exchanger 14 with a low-temperature refrigerant discharged from the third heat-exchanger 16, and may respectively supply the heat-exchanged refrigerants to the third heat-exchanger 16 and the compressor 10.

In an embodiment of the present disclosure, the chiller 20 may be connected to an electrical component 3 through a first line 2 through which the coolant circulates.

The electrical component 3 may include a power conversion device such as an electrical power control unit (EPCU), a motor, an inverter, or an on-board charger (OBC), and an autonomous driving controller, or the like.

The electrical component 3 configured as such may be connected to the first line 2 to be cooled in a water-cooled manner.

The chiller 20 may adjust the temperature of the electrical component 3 by using the coolant heat-exchanged with the refrigerant, and may recollect a waste heat of the electrical component 3.

In addition, the chiller 20 may be connected to the battery module 5 through a second line 4 through which the coolant circulates. Accordingly, the coolant may selectively circulate through the chiller 20.

The chiller 20 may adjust a temperature of the coolant by heat-exchanging the supplied refrigerant with the coolant. In other words, the chiller 20 may be a water-cooled gas cooler configured to heat-exchange the interiorly introduced refrigerant with the coolant.

The chiller 20 may be connected to the refrigerant line 11 through a first connection line 21.

A first end of the first connection line 21 may be connected to the refrigerant line 11 between the second heat-exchanger 14 and the first expansion valve 15. In addition, a second end of the first connection line 21 may be connected to the refrigerant line 11 between the third heat-exchanger 16 and the accumulator 17.

In other words, the chiller 20 may adjust the temperature of the coolant by heat-exchanging the coolant selectively introduced through the first line 2 or the second line 4 with the selectively supplied refrigerant.

Accordingly, the coolant heat-exchanged in the chiller 20 may circulate the electrical component 3 through the first line 2. In addition, the coolant heat-exchanged in the chiller 20 may circulate the battery module 5 through the second line 4.

The first line 2 and a water pump (not shown) may be provided on the second line 4.

In other words, the coolant may circulate along the first line 2 and the second line 4 according to an operation of each water pump (not shown).

Accordingly, the coolant heat-exchanged with the refrigerant in the chiller 20 may adjust the electrical component 3 and the temperature of the battery module 5, while being selectively supplied to the electrical component 3 and the battery module 5.

The heat pump system may further include a first valve 18, a second valve 19, a second expansion valve 23, a third expansion valve 25, a second connection line 31, a fourth expansion valve 33, a third connection line 41, a third valve 43, a fourth connection line 51, a fifth expansion valve 53, a fifth connection line 61, a fourth valve 63, a sixth connection line 71, and a sixth expansion valve 73.

The first valve 18 may be provided on the refrigerant line 11 between the first heat-exchanger 13 and the second heat-exchanger 14.

The first valve 18 may selectively open and close the refrigerant line 11 so that the refrigerant discharged from the first heat-exchanger 13 is selectively introduced into the second heat-exchanger 14.

In an embodiment of the present disclosure, the second valve 19 may be provided on the refrigerant line 11 between the third heat-exchanger 16 and the compressor 10. The second valve 19 may be provided on the refrigerant line 11 between the third expansion valve 25 and the accumulator 17.

The second valve 19 may open the refrigerant line 11 so that at least one refrigerant among the refrigerant discharged from the third heat-exchanger 16 and the refrigerant discharged from the chiller 20 is introduced into the accumulator 17. The second valve 19 may close the refrigerant line 11 so that one of the refrigerant discharged from the third heat-exchanger 16 and the refrigerant discharged from the chiller 20 is not introduced into the accumulator 17.

In other words, when the battery module 5 is to be heated, the second valve 19 may close the refrigerant line 11 so that the refrigerant discharged from the chiller 20 is not introduced into the accumulator 17.

In addition, when the battery module 5 is to be heated at the time of heating of the vehicle interior, the second valve 19 may close the refrigerant line 11 so that the refrigerant discharged from the third heat-exchanger 16 and the refrigerant discharged from the chiller 20 are not introduced together into the accumulator 17.

In a cooling mode of the vehicle interior or a hot gas heating mode of the vehicle interior, the second valve 19 may open the refrigerant line 11 so that the refrigerant discharged from the third heat-exchanger 16 and the refrigerant discharged from the chiller 20 are introduced together into the accumulator 17.

In addition, in the heating mode of the vehicle interior, the second valve 19 may open the refrigerant line 11 so that the refrigerant discharged from the chiller 20 is introduced into the accumulator 17.

In addition, the second valve 19 may open the refrigerant line 11 in a heating-and-dehumidifying mode of the vehicle interior, so that the refrigerant discharged from the third heat-exchanger 16 is introduced into the accumulator 17.

The second expansion valve 23 may be provided on the first connection line 21.

The second expansion valve 23 may selectively expand the refrigerant introduced into the first connection line 21 and allow the selectively expanded refrigerant to flow into the chiller 20, depending on the selected air conditioning mode of the vehicle interior.

In addition, the second expansion valve 23 may supply the refrigerant introduced into the first connection line 21 to the chiller 20 without expansion, or may close the first connection line 21 so that the refrigerant is not supplied to the chiller 20.

In other words, the second expansion valve 23 may selectively expand the refrigerant while controlling the flowing movement of the refrigerant.

When cooling the battery module 5 by using the coolant heat-exchanged with the refrigerant in the chiller 20, the second expansion valve 23 may open the first connection line 21. The second expansion valve 23 may expand the refrigerant introduced into the first connection line 21 and allow the expanded refrigerant to flow into the chiller 20.

In other words, the second expansion valve 23 may expand the refrigerant discharged from the second heat-exchanger 14 to lower its temperature and allow the expanded refrigerant to flow into the chiller 20, and thereby may further lower temperature of the coolant passing through the interior of the chiller 20.

Accordingly, the coolant having its temperature decreased while passing through the chiller 20 may be introduced into the battery module 5, thereby achieving more efficient cooling.

The third expansion valve 25 may be provided on the refrigerant line 11 between the third heat-exchanger 16 and the compressor 10. The third expansion valve 25 may be provided on the refrigerant line 11 between the third heat-exchanger 16 and the second valve 19.

The third expansion valve 25 may allow the refrigerant introduced through the refrigerant line 11 to flow in a selectively expanded or unexpanded state, depending on the selected air conditioning mode of the vehicle interior.

In other words, the third expansion valve 25 may selectively expand the refrigerant while controlling the flowing movement of the refrigerant.

In an embodiment of the present disclosure, a first end of the second connection line 31 may be connected to the refrigerant line 11 between the first heat-exchanger 13 and the second heat-exchanger 14. A second end of the second connection line 31 may be connected to the refrigerant line 11 between the second heat-exchanger 14 and the third heat-exchanger 16.

The fourth expansion valve 33 may be provided on the second connection line 31. The fourth expansion valve 33 may selectively open and close the second connection line 31, and may selectively expand the refrigerant introduced through the second connection line 31.

In the cooling mode of the vehicle interior, the fourth expansion valve 33 may close the second connection line 31. On the other hand, in the heating mode of the vehicle interior, the fourth expansion valve 33 may open the second connection line 31.

In addition, in the heating-and-dehumidifying mode of the vehicle interior, the fourth expansion valve 33 may open the second connection line 31, and may expand the refrigerant introduced through the second connection line 31.

In other words, the fourth expansion valve 33 may selectively expand the refrigerant while controlling the flowing movement of the refrigerant.

In an embodiment of the present disclosure, a first end of the third connection line 41 may be connected to the refrigerant line 11 between the compressor 10 and the first heat-exchanger 13. A second end of the third connection line 41 may be connected to the refrigerant line 11 between the first heat-exchanger 13 and the second heat-exchanger 14.

The third valve 43 may be provided on the third connection line 41. The third valve 43 may selectively open and close the third connection line 41.

In other words, in the cooling mode of the vehicle interior, the third valve 43 may open the third connection line 41. In the heating mode of the vehicle interior and in the heating-and-dehumidifying mode of the vehicle interior, the third valve 43 may close a portion of the third connection line 41.

A first end of the fourth connection line 51 may be connected to the refrigerant line 11 between the second heat-exchanger 14 and the third heat-exchanger 16. A second end of the fourth connection line 51 may be connected to the refrigerant line 11 between the third heat-exchanger 16 and the third expansion valve 25.

The fifth expansion valve 53 may be provided on the fourth connection line 51.

The fifth expansion valve 53 may selectively open and close the fourth connection line 51, to control the flowing movement of the refrigerant, and may selectively expand the refrigerant introduced into the fourth connection line 51.

In the heating mode of the vehicle interior, the fifth expansion valve 53 may open the fourth connection line 51, may expand the refrigerant introduced through the fourth connection line 51 and may respectively supply the expanded refrigerant to the second heat-exchanger 14 and the internal heat-exchanger 17a.

Accordingly, in the heating mode of the vehicle interior, the second heat-exchanger 14 may evaporate the refrigerant through heat-exchange with the air introduced from the outside.

The refrigerant having passed through the internal heat-exchanger 17a may be supplied to the chiller 20. The chiller 20 may evaporate the refrigerant through heat-exchange with the coolant supplied through the first line 2.

In the cooling mode of the vehicle interior or the heating-and-dehumidifying mode of the vehicle interior, the fifth expansion valve 53 may close the fourth connection line 51.

In other words, the fifth expansion valve 53 may selectively expand the refrigerant while controlling the flowing movement of the refrigerant.

In an embodiment of the present disclosure, a first end of the fifth connection line 61 may be connected to the refrigerant line 11 between the second valve 19 and the compressor 10. A second end of the fifth connection line 61 may be connected to the refrigerant line 11 between the first heat-exchanger 13 and the second heat-exchanger 14.

The fourth valve 63 may be provided on the fifth connection line 61. The fourth valve 63 may control the flowing movement of the refrigerant by selectively opening and closing the fifth connection line 61.

In the cooling mode of the vehicle interior, or in the heating-and-dehumidifying mode of the vehicle interior, or in the hot gas heating mode of the vehicle interior, the fourth valve 63 may close the fifth connection line 61.

When the heating mode of the vehicle interior, or the battery module is to be heated in the heating mode of the vehicle interior, or when the battery module is to be heated, or the heating mode of the vehicle interior, the fourth valve 63 may open the fifth connection line 61.

In addition, a first end of the sixth connection line 71 may be connected to the first connection line 21 between the second expansion valve 23 and the chiller 20. A second end of the sixth connection line 71 may be connected to the third connection line 41.

The sixth expansion valve 73 may be provided on the sixth connection line 71. The sixth expansion valve 73 may control the flowing movement of the refrigerant by selectively opening and closing the sixth connection line 71, and may selectively expand the refrigerant introduced into the sixth connection line 71.

In more detail, in the hot gas heating mode of the vehicle interior, the sixth expansion valve 73 may open the sixth connection line 71, may expand the refrigerant introduced through the sixth connection line 71, and may supply the expand refrigerant to the chiller 20.

In the cooling mode of the vehicle interior, or in the heating mode of the vehicle interior, or in the heating-and-dehumidifying mode of the vehicle interior, the sixth expansion valve 73 may close the sixth connection line 71.

In addition, when the battery module 5 is to be heated in the heating mode of the vehicle interior, or when the battery module 5 is to be heated, the sixth expansion valve 73 may open the sixth connection line 71, and may supply the refrigerant introduced through the sixth connection line 71 to the chiller 20 without expansion.

In other words, the sixth expansion valve 73 may selectively expand the refrigerant while controlling the flowing movement of the refrigerant.

The first valve 18, the second valve 19, the third valve 43, and the fourth valve 63 may be 2-way valves opening and closing the refrigerant line 11, the third connection line 41, and the fifth connection line 61, and controlling the flow rate of the refrigerant.

In addition, the first expansion valve 15, the second expansion valve 23, the third expansion valve 25, the fourth expansion valve 33, the fifth expansion valve 53, and the sixth expansion valve 73 may be electronic expansion valves configured to selectively expand the refrigerant while controlling the flowing movement of the refrigerant.

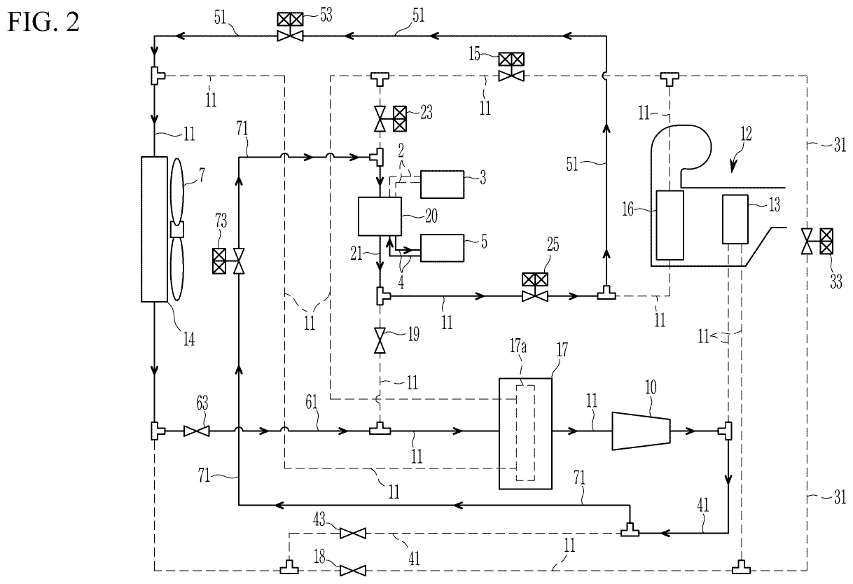

Hereinafter, an operation and action of a heat pump system for a vehicle according to an embodiment of the present disclosure configured as described above are described in detail with reference to FIGS. 2-7.

An operation for heating the battery module 5, when the temperature of the battery module 5 is low, is described in detail with reference to FIG. 2.

FIG. 2 is an operation diagram of a heat pump system for a vehicle according to an embodiment of the present disclosure, for heating a battery module.

Referring to FIG. 2, the heat pump system may increase the temperature of the battery module 5 by using the coolant heat-exchanged with the refrigerant.

The coolant does not circulate through the first line 2. The coolant may circulate along the second line 4 by an operation of a water pump (not shown).

Accordingly, the coolant having passed through the battery module 5 may be supplied to the chiller 20 along the second line 4.

In the heat pump system, respective components may operate in order to the heat battery module 5. Accordingly, the refrigerant may circulate along the refrigerant line 11.

A portion of the refrigerant line 11 connecting the compressor 10 and the first heat-exchanger 13, and the portion of the refrigerant line 11 connecting the first heat-exchanger 13 and the second heat-exchanger 14 may be closed by the first valve 18.

The portion of the refrigerant line 11 connecting the first end of the fifth connection line 61 and the compressor 10 may be opened.

In addition, the portion of the refrigerant line 11 connected to the second heat-exchanger 14 may be opened so that the first end of the fourth connection line 51 and the second end of the fifth connection line 61 are connected.

In addition, the portion of the refrigerant line 11 connecting the second end of the first connection line 21 and the second end of the fourth connection line 51 may be opened by the third expansion valve 25.

The third expansion valve 25 may allow the refrigerant introduced through the refrigerant line 11 to flow without expansion.

In addition, the portion of the refrigerant line 11 connecting the second end of the first connection line 21 and the first end of the fifth connection line 61 may be closed by the second valve 19.

A portion of the first connection line 21 connecting the first end of the sixth connection line 71 and the chiller 20 may be opened.

In addition, the remaining portion of first connection line 21 connecting the refrigerant line 11 and the sixth connection line 71 on an upstream end of the chiller 20 may be closed by the second expansion valve 23.

The second connection line 31 may be closed by the fourth expansion valve 33.

In addition, a portion of the third connection line 41 may be opened so that a portion of the refrigerant line 11 connected to the compressor 10 and the sixth connection line 71 are connected.

The remaining portion of the third connection line 41 may be closed by the third valve 43.

The fourth connection line 51 may be opened by the fifth expansion valve 53.

The fifth expansion valve 53 may expand the refrigerant introduced through the fourth connection line 51.

The fifth connection line 61 may be opened by the fourth valve 63. In addition, the sixth connection line 71 may be opened by the sixth expansion valve 73.

The sixth expansion valve 73 may allow the refrigerant introduced through the sixth connection line 71 to flow without expansion. Accordingly, the refrigerant discharged from the sixth expansion valve 73 may be supplied to the chiller 20 in an unexpanded state.

Accordingly, the refrigerant discharged from the compressor 10 may be introduced into the chiller 20 sequentially along a portion of the third connection line 41, the sixth connection line 71, and a portion of the first connection line 21.

In addition, the chiller 20 may cool the unexpanded refrigerant through heat-exchange with the coolant supplied through the first line 2.

The refrigerant introduced into the chiller 20 may increase the temperature of the coolant while heat-exchanging with the coolant supplied from the battery module 5 through the second line 4.

The coolant heated in the chiller 20 may be supplied to the battery module 5 along the second line 2. Accordingly, the temperature of the battery module 5 may be efficiently increased by the coolant heated in the chiller 20.

The refrigerant having passed through the chiller 20 may be introduced into the second heat-exchanger 14 along a portion of the first connection line 21, the fourth connection line 51 and the opened portion of the refrigerant lines 11.

The fifth expansion valve 53 may expand the refrigerant so that the expanded refrigerant is supplied to the second heat-exchanger 14.

Accordingly, the second heat-exchanger 14 may evaporate the expanded refrigerant through heat-exchange with the externally introduced air.

Then, the refrigerant discharged from the second heat-exchanger 14 may pass through the internal heat-exchanger 17a and the accumulator 17 along the portion of the refrigerant lines 11 and the fifth connection line 61, to be supplied to the compressor 10.

While repeatedly performing such an operation, the coolant heated through heat-exchange with the refrigerant in the chiller 20 may be supplied to the battery module 5, along the second line 4. Accordingly, the battery module 5 may be rapidly heated by the coolant heated in the chiller 20.

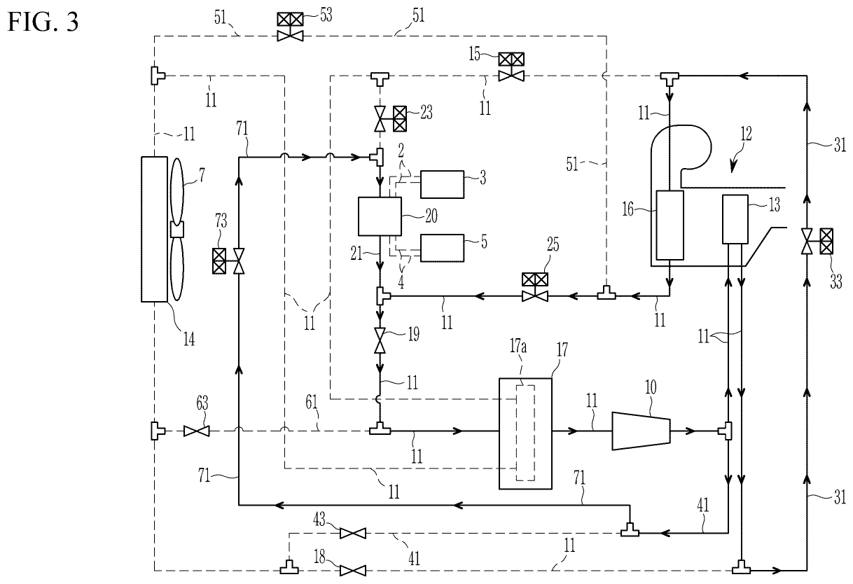

In an embodiment of the present disclosure, an operation in the hot gas heating mode of the vehicle interior is described in detail with reference to FIG. 3.

FIG. 3 is an operation diagram of a heat pump system for a vehicle according to an embodiment of the present disclosure, for the hot gas heating mode of the vehicle interior.

Referring to FIG. 3, when an ambient air heat, the waste heat of the electrical component 3, and the waste heat of the battery module 5 is not sufficient, the heat pump system may not recollect heat.

In other words, when heating of the vehicle interior is required while the external temperature low and the heat generated from the electrical component 3 and the battery module 5 is not sufficient in an early state of driving the vehicle, the heat pump system may perform heating of the vehicle interior by directly using a high-pressure and high-temperature refrigerant.

As such, heating the vehicle interior by using only the refrigerant may be referred to as a hot gas heating mode.

In an embodiment of the present disclosure, in the hot gas heating mode of the vehicle interior, the coolant may not flow through the first line 2 and the second line 4. In other words, the first line 2 and the second line 4 may be closed.

In other words, since the heat generated from the electrical component 3 and the battery module 5 is not sufficient, the coolant may not be introduced into the chiller 20.

In such a state, in the heat pump system, respective components may operate in order to perform the hot gas heating mode of the vehicle interior. Accordingly, the refrigerant may circulate along the refrigerant line 11.

The portion of the refrigerant line 11 connecting the first end of the first connection line 21 to the second end of the second connection line 31 may be closed by the first expansion valve 15.

The portion of the refrigerant line 11 connecting the first end of the second connection line 31 and the second end of the fifth connection line 61 may be closed by the first valve 18.

In addition, the portion of the refrigerant line 11 connecting the second end of the second connection line 31 to the second end of the first connection line 21 by passing through the third heat-exchanger 16 may be opened by the third expansion valve 25.

The third expansion valve 25 may allow the introduced refrigerant to flow in an expanded state.

The portion of the refrigerant line 11 connecting the second end of the first connection line 21 and the first end of the fifth connection line 61 may be opened by the second valve 19.

In addition, the portion of the refrigerant line 11 connecting the second end of the fifth connection line 61 to the first end of the first connection line 21 via the second heat-exchanger 14 may be closed.

A portion of the first connection line 21 connecting the first end of the sixth connection line 71 and the chiller 20 may be opened.

In addition, the remaining portion of the first connection line 21 connecting the refrigerant line 11 and the sixth connection line 71 at the upstream end of the chiller 20 may be closed by the second expansion valve 23.

The second connection line 31 may be opened by the fourth expansion valve 33. The fourth expansion valve 33 may allow the introduced refrigerant to flow without expansion so that the unexpanded refrigerant is introduced into the third heat-exchanger 16.

Accordingly, the first heat-exchanger 13 and the third heat-exchanger 16 may cool the refrigerant through heat-exchange with the air introduced into the HVAC module 12.

In an embodiment of the present disclosure, a portion of the third connection line 41 may be opened so that a portion of the refrigerant line 11 connected to the compressor 10 and the sixth connection line 71 are connected. In addition, the remaining portion of the third connection line 41 may be closed by the third valve 43.

The fourth connection line 51 may be closed by the fifth expansion valve 53. The fifth connection line 61 may be closed by the fourth valve 63.

In addition, the sixth connection line 71 may be opened by the sixth expansion valve 73. The sixth expansion valve 73 may allow the introduced refrigerant to flow in an expanded state so that the expanded refrigerant is introduced into the chiller 20.

Accordingly, a partial refrigerant among the refrigerant discharged from the compressor 10 may be introduced into the first heat-exchanger 13 along the refrigerant line 11. In addition, the refrigerant having passed through the first heat-exchanger 13 may be introduced into the third heat-exchanger 16 along the second connection line 31 and the opened refrigerant line 11.

The refrigerant each supplied to the first heat-exchanger 13 and the third heat-exchanger 16 may increase the temperature of the air introduced into the HVAC module 12.

The air introduced into the HVAC module 12 from the outside may be converted into a high-temperature state while sequentially passing through the third heat-exchanger 16 the first heat-exchanger 13 and introduced into the vehicle interior, thereby implementing heating of the vehicle interior.

A remaining refrigerant among the refrigerant discharged from the compressor 10 may be introduced into the chiller 20 along a portion of the third connection line 41, the sixth connection line 71, and the opened first connection line 21.

The refrigerant expanded while passing through the third expansion valve 25 from the third heat-exchanger 16, and the refrigerant discharged from the chiller 20 may pass through the internal heat-exchanger 17a and the accumulator 17 along the portion of the refrigerant line 11, to be supplied to the compressor 10.

The refrigerant introduced into the compressor 10 may be respectively supplied to the first heat-exchanger 13 and the chiller 20 again.

In other words, in an embodiment of the present disclosure, when the heat source is not sufficient in an early stage of driving the vehicle while the external temperature is low, while repeatedly performing the above-described operations, the vehicle interior may be heated by using the high-temperature refrigerant supplied from the compressor 10.

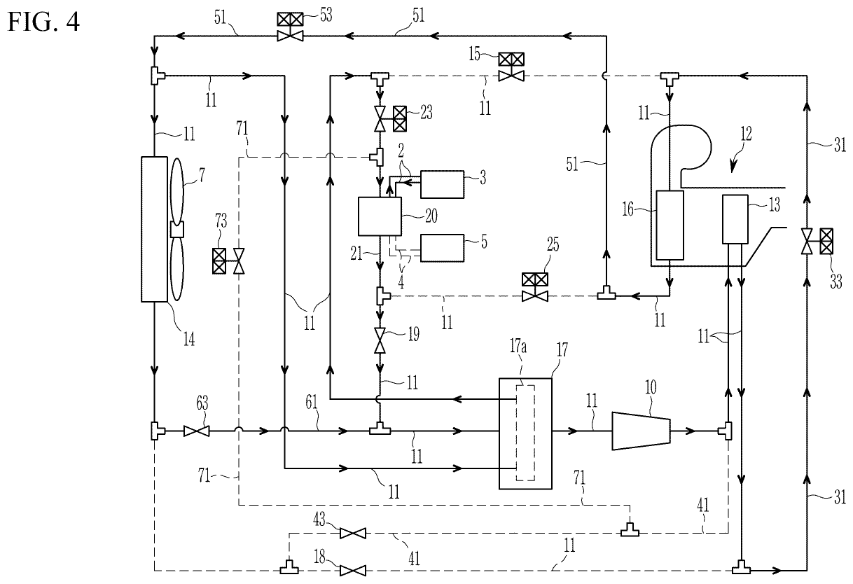

In an embodiment of the present disclosure, an operation for the heating mode of the vehicle interior is described in detail with reference to FIG. 4.

FIG. 4 is an operation diagram according to the heating mode of the vehicle interior in a heat pump system for a vehicle according to an embodiment of the present disclosure.

Referring to FIG. 4, the coolant may circulate along the first line 2 by the operation of a water pump (not shown). The coolant may not flow through the second line 4. In other words, the second line 4 may be closed.

Accordingly, the coolant having passed through the electrical component 3 may be supplied to the chiller 20 along the first line 2.

In the heat pump system. respective components may operate in order to heat the vehicle interior. Accordingly, the refrigerant may circulate along the refrigerant line 11.

The portion of the refrigerant line 11 connecting the first end of the first connection line 21 to the second end of the second connection line 31 may be closed by the first expansion valve 15.

The portion of the refrigerant line 11 connecting the first end of the second connection line 31 and the second end of the fifth connection line 61 may be closed by the first valve 18.

In addition, the portion of the refrigerant line 11 connecting the second end of the fourth connection line 51 and the second end of the first connection line 21 may be closed by the third expansion valve 25.

In addition, the portion of the refrigerant line 11 connecting the second end of the first connection line 21 and the first end of the fifth connection line 61 may be opened by the second valve 19.

The first connection line 21 may be opened by the second expansion valve 23. The second expansion valve 23 may supply the refrigerant introduced through the first connection line 21 to the chiller 20 without expansion.

The second connection line 31 may be opened by the fourth expansion valve 33. The fourth expansion valve 33 may supply the refrigerant introduced through the second connection line 31 to the third heat-exchanger 16 without expansion.

Accordingly, the first heat-exchanger 13 and the third heat-exchanger 16 may cool the introduced refrigerant by using the air introduced into the HVAC module 12.

In an embodiment of the present disclosure, the third connection line 41 may be closed by the third valve 43. The fourth connection line 51 may be opened by the fifth expansion valve 53.

Accordingly, a partial refrigerant among the refrigerant introduced into the fourth connection line 51 from the third heat-exchanger 16 may be introduced into the second heat-exchanger 14.

A remaining refrigerant among the refrigerant introduced into the fourth connection line 51 from the third heat-exchanger 16 may be introduced into the internal heat-exchanger 17a along the refrigerant line 11.

The fifth expansion valve 53 may expand the refrigerant so that the expanded refrigerant is respectively supplied to the second heat-exchanger 14, the internal heat-exchanger 17a, and the chiller 20.

Accordingly, the second heat-exchanger 14 may evaporate the expanded refrigerant through heat-exchange with the externally introduced air. The second heat-exchanger 14 may recollect the ambient air heat while evaporating the expanded refrigerant through heat-exchange with air.

In addition, the chiller 20 may evaporate the expanded refrigerant through heat-exchange with the coolant supplied through the first line 2. The chiller 20 may recollect the waste heat of the electrical component 3 from the coolant heated by recollecting the waste heat from the electrical component 3.

The fifth connection line 61 may be opened by the fourth valve 63. In addition, the sixth connection line 71 may be closed by the sixth expansion valve 73.

Accordingly, the refrigerant discharged from the second heat-exchanger 14 may flow along the fifth connection line 61, and the refrigerant discharged from the chiller 20 may flow along the first connection line 21.

The refrigerant flowing through the first connection line 21 and the fifth connection line 61 respectively may pass through the internal heat-exchanger 17a and the accumulator 17 along the refrigerant line 11, to be then supplied to the compressor 10.

In other words, a partial refrigerant among the refrigerant expanded in the fifth expansion valve 53 may be introduced into the chiller 20 after passing through the internal heat-exchanger 17a along the refrigerant line 11.

In addition, the refrigerant discharged from the second heat-exchanger 14 and the chiller 20 may be supplied to the compressor 10 after passing through the internal heat-exchanger 17a and the accumulator 17.

In such a state, the refrigerant supplied from the compressor 10 may be introduced into the first heat-exchanger 13 along the refrigerant line 11. The refrigerant having passed through the first heat-exchanger 13 may flow along the second connection line 31 connected to the refrigerant line 11.

The refrigerant flowing along the second connection line 31 may be introduced into the third heat-exchanger 16 along the refrigerant line 11 connected to the third heat-exchanger 16.

The first heat-exchanger 13 and the third heat-exchanger 16 may cool the refrigerant by heat-exchanging the air introduced into the HVAC module 12 with the refrigerant. The refrigerant primarily cooled in the first heat-exchanger 13 may be additionally cooled in the third heat-exchanger 16.

In other words, when the refrigerant having passed through the first heat-exchanger 13 is supplied to the third heat-exchanger 16 without being expanded by the fourth expansion valve 33, the third heat-exchanger 16 may cool the refrigerant by heat-exchanging the air introduced into the HVAC module 12 with the refrigerant.

The refrigerant having passed through the third heat-exchanger 16 may flow along the opened fourth connection line 51. The refrigerant introduced into the fourth connection line 51 may be expanded by an operation of the fifth expansion valve 53.

A partial refrigerant among the refrigerant expanded in the fifth expansion valve 53 may flow along the refrigerant line 11 connected to the internal heat-exchanger 17a, to be introduced into the internal heat-exchanger 17a.

The refrigerant having passed through the internal heat-exchanger 17a may pass through the chiller 20 along the refrigerant line 11 and the first connection line 21, and then pass through the internal heat-exchanger 17a and the accumulator 17.

A remaining refrigerant among the refrigerant expanded in the fifth expansion valve 53 may pass through the second heat-exchanger 14, and then flow along the fifth connection line 61. The refrigerant flowing along the fifth connection line 61 may pass through the internal heat-exchanger 17a and the accumulator 17, together with the refrigerant having passed through the chiller 20.

Accordingly, the second heat-exchanger 14 may evaporate the supplied refrigerant through heat-exchange with air, and at the same time, the chiller 20 may evaporate through heat-exchange the supplied refrigerant with the coolant.

While repeatedly performing such an operation, the second heat-exchanger 14 and the chiller 20 may recollect the ambient air heat and the waste heat of the electrical component 3.

In other words, by using the recollected waste heat of the electrical component 3 and ambient air heat to increase the temperature of the refrigerant, the heat pump system may decrease the power consumption of the compressor 10, and may improve the heating efficiency.

In addition, the refrigerant having passed through the accumulator 17 may be supplied to the compressor 10.

The refrigerant compressed to the high-temperature and high-pressure state in the compressor 10 may be introduced into the first heat-exchanger 13 along the refrigerant line 11, again.

As described above, the refrigerant respectively supplied to the first heat-exchanger 13 and the third heat-exchanger 16 may increase the temperature of the air introduced into the HVAC module 12.

Accordingly, the air introduced from the outside may be converted into a high-temperature state while sequentially passing through the third heat-exchanger 16 the first heat-exchanger 13 and introduced into the vehicle interior, thereby implementing heating of the vehicle interior.

Although not shown in the drawings, when the waste heat of the battery module 5 is to be recollected together, the coolant may circulate along the second line 4 by the operation of a water pump (not shown). Accordingly, the coolant having passed through the battery module 5 may be supplied to the chiller 20 along the second line 4.

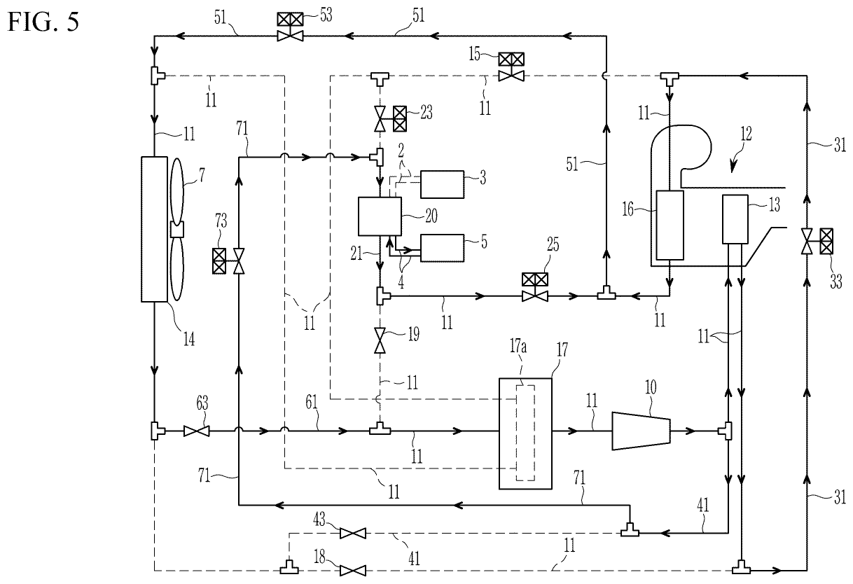

In an embodiment of the present disclosure, an operation of heating the battery module 5 in the heating mode of the vehicle interior is described in detail with reference to FIG. 5.

FIG. 5 is an operation diagram of a heat pump system for a vehicle according to an embodiment of the present disclosure, for heating a battery module in the heating mode of the vehicle interior.

Referring to FIG. 5, the heat pump system may increase the temperature of the battery module 5 by using the coolant heat-exchanged with the refrigerant while heating the vehicle interior.

The coolant does not circulate through the first line 2. The coolant may circulate along the second line 4 by the operation of a water pump (not shown).

Accordingly, the coolant having passed through the battery module 5 may be supplied to the chiller 20 along the second line 4.

In the heat pump system. respective components may operate in order to heat the vehicle interior. Accordingly, the refrigerant may circulate along the refrigerant line 11.

The portion of the refrigerant line 11 connecting the first end of the first connection line 21 to the second end of the second connection line 31, and the portion of the refrigerant line 11 connecting the first end of the fourth connection line 51 to the first end of the first connection line 21 may be closed by the first expansion valve 15.

The portion of the refrigerant line 11 connecting the first end of the second connection line 31 and the second end of the fifth connection line 61 may be closed by the first valve 18.

The portion of the refrigerant line 11 connecting the second end of the second connection line 31 to the second end of the first connection line 21 by passing through the third heat-exchanger 16 may be opened by the third expansion valve 25.

The third expansion valve 25 may allow the refrigerant introduced through the refrigerant line 11 to flow without expansion.

In addition, the portion of the refrigerant line 11 connecting the second end of the first connection line 21 and the first end of the fifth connection line 61 may be closed by the second valve 19.

In addition, the portion of the refrigerant line 11 connected to the second heat-exchanger 14 may be opened so that the first end of the fourth connection line 51 and the second end of the fifth connection line 61 are connected.

A portion of the first connection line 21 connecting the first end of the sixth connection line 71 and the chiller 20 may be opened.

In addition, the remaining portion of the first connection line 21 connecting the refrigerant line 11 and the sixth connection line 71 at the upstream end of the chiller 20 may be closed by the second expansion valve 23.

The second connection line 31 may be opened by the fourth expansion valve 33.

The fourth expansion valve 33 may allow the refrigerant introduced through the second connection line 31 to flow without expansion.

In addition, a portion of the third connection line 41 may be opened so that a portion of the refrigerant line 11 connected to the compressor 10 and the sixth connection line 71 are connected.

A remaining portion of the third connection line 41 may be closed by the third valve 43.

The fourth connection line 51 may be opened by the fifth expansion valve 53.

The fifth expansion valve 53 may expand the refrigerant introduced through the fourth connection line 51. The refrigerant expanded in the fifth expansion valve 53 may be introduced into the second heat-exchanger 14.

The fifth connection line 61 may be opened by the fourth valve 63. In addition, the sixth connection line 71 may be opened by the sixth expansion valve 73.

The sixth expansion valve 73 may allow the refrigerant introduced through the sixth connection line 71 to flow without expansion. Accordingly, the refrigerant discharged from the sixth expansion valve 73 may be supplied to the chiller 20 in an unexpanded state.

Accordingly, a partial refrigerant among the refrigerant discharged from the compressor 10 may be introduced into the first heat-exchanger 13 along the refrigerant line 11. In addition, the refrigerant having passed through the first heat-exchanger 13 may be introduced into the third heat-exchanger 16 along the second connection line 31 and the opened refrigerant line 11.

The refrigerant respectively supplied to the first heat-exchanger 13 and the third heat-exchanger 16 may increase the temperature of the air introduced into the HVAC module 12.

The air introduced into the HVAC module 12 from the outside may be converted into a high-temperature state while sequentially passing through the third heat-exchanger 16 the first heat-exchanger 13 and introduced into the vehicle interior, thereby implementing heating of the vehicle interior.

A remaining refrigerant among the refrigerant discharged from the compressor 10 may be introduced into the chiller 20 along a portion of the third connection line 41, the sixth connection line 71, and the opened first connection line 21.

The refrigerant introduced into the chiller 20 may increase the temperature of the coolant while heat-exchanging with the coolant supplied from the battery module 5 through the second line 4.

The coolant heated in the chiller 20 may be supplied to the battery module 5 along the second line 4. Accordingly, the temperature of the battery module 5 may be efficiently increased by the coolant heated in the chiller 20.

The refrigerant having passed through the third heat-exchanger 16, and the refrigerant having passed through the third expansion valve 25 from the chiller 20 may flow along the fourth connection line 51 and the portion of the refrigerant line 11, to be supplied to the second heat-exchanger 14.

The fifth expansion valve 53 may expand the refrigerant so that the expanded refrigerant is supplied to the second heat-exchanger 14.

Accordingly, the second heat-exchanger 14 may evaporate the expanded refrigerant through heat-exchange with the externally introduced air.

The refrigerant discharged from the second heat-exchanger 14 may pass through the internal heat-exchanger 17a and the accumulator 17 along the portion of the refrigerant lines 11 and the fifth connection line 61, to be then supplied to the compressor 10.

The refrigerant compressed to the high-temperature and high-pressure state in the compressor 10 may be respectively supplied to the first heat-exchanger 13 and the chiller 20 again.

As described above, the refrigerant respectively supplied to the first heat-exchanger 13 and the third heat-exchanger 16 may increase the temperature of the air introduced into the HVAC module 12.

Accordingly, the air introduced from the outside may be converted into a high-temperature state while sequentially passing through the third heat-exchanger 16 the first heat-exchanger 13 and introduced into the vehicle interior, thereby implementing heating of the vehicle interior.

The coolant heated through heat-exchange with the refrigerant in the chiller 20 may be supplied to the battery module 5, along the second line 4. Accordingly, the battery module 5 may be rapidly heated by the coolant heated in the chiller 20.

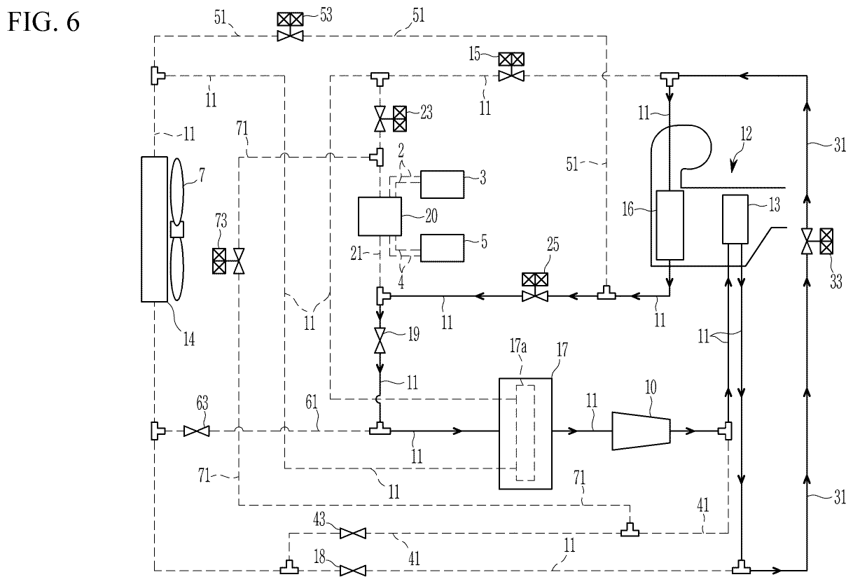

In an embodiment of the present disclosure, an operation in the heating-and-dehumidifying mode of the vehicle interior is described in detail with reference to FIG. 6.

FIG. 6 is an operation diagram according to the heating-and-dehumidifying mode of the vehicle interior in a heat pump system for a vehicle according to an embodiment of the present disclosure.

Referring to FIG. 6, the coolant may not flow through the first line 2 and the second line 4. In other words, the first line 2 and the second line 4 may be closed.

In such a state, in the heat pump system, respective components may operate in order to heat and dehumidify the vehicle interior. Accordingly, the refrigerant may circulate along the refrigerant line 11.

The portion of the refrigerant line 11 connecting the first end of the first connection line 21 and the second end of the second connection line 31 may be closed by the first expansion valve 15.

In addition, the portion of the refrigerant line 11 connecting the first end of the second connection line 31 and the second heat-exchanger 14 may be closed by the first valve 18.

The refrigerant line 11 connecting the third heat-exchanger 16 and the accumulator 17 may be opened by the second valve 19 and the third expansion valve 25.

The third expansion valve 25 may allow the introduced refrigerant to flow without expansion.

In addition, the portion of the refrigerant line 11 connecting the second heat-exchanger 14 to the internal heat-exchanger 17a and the first end of the first connection line 21 may be closed.

The first connection line 21 may be closed by the second expansion valve 23. The second connection line 31 may be opened by the fourth expansion valve 33.

The fourth expansion valve 33 may expand the refrigerant introduced through the second connection line 31 from the first heat-exchanger 13. Thereafter, the fourth expansion valve 33 may supply the expanded refrigerant to the third heat-exchanger 16.

Accordingly, the first heat-exchanger 13 may cool the introduced refrigerant by using the air introduced into the HVAC module 12.

In addition, the third heat-exchanger 16 may recollect the ambient air heat while evaporating the expanded refrigerant through heat-exchange with the air introduced into the HVAC module 12.

In other words, since the heat pump system uses the recollected ambient air heat to increase the temperature of the refrigerant, the power consumption of the compressor 10 may be decreased, and the heating efficiency may be improved.

In an embodiment of the present disclosure, the third connection line 41 may be closed by the third valve 43. The fourth connection line 51 may be closed by the fifth expansion valve 53.

In addition, the fifth connection line 61 may be closed by the fourth valve 63. In addition, the sixth connection line 71 may be closed by the sixth expansion valve 73.

Accordingly, the refrigerant discharged from the compressor 10, or the refrigerant discharged from the first heat-exchanger 13 may not be introduced into the second heat-exchanger 14.

In other words, the refrigerant discharged from the compressor 10 may be introduced into the first heat-exchanger 13 along the portion of the refrigerant line 11. The refrigerant having passed through the first heat-exchanger 13 may flow along the second connection line 31 connected to the refrigerant line 11.

The refrigerant flowing along the second connection line 31 may be expanded by an operation of the fourth expansion valve 33. Thereafter, the expanded refrigerant may be introduced into the third heat-exchanger 16.

The refrigerant having passed through the third heat-exchanger 16 may pass through the internal heat-exchanger 17a and the accumulator 17 along the opened portion of the refrigerant line 11.

In addition, the refrigerant having passed through the accumulator 17 may be supplied to the compressor 10.

In addition, the refrigerant compressed to the high-temperature and high-pressure state in the compressor 10 may be introduced into the first heat-exchanger 13 along the refrigerant line 11.

As described above, the refrigerant supplied to the first heat-exchanger 13 may increase the temperature of the air introduced into the HVAC module 12.

In other words, the air introduced into the HVAC module 12 may be dehumidified by the low-temperature refrigerant introduced into the third heat-exchanger 16 while passing through the third heat-exchanger 16. Thereafter, it is converted into a high-temperature state while passing through the first heat-exchanger 13 and introduced into the vehicle interior, thereby smoothly heating-and-dehumidifying the vehicle interior.

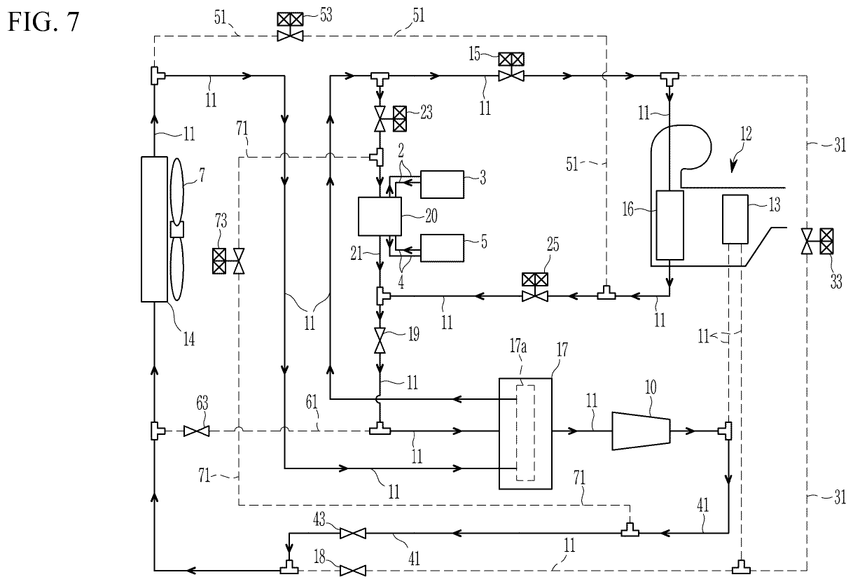

In addition, an operation for cooling the battery module 5 in the cooling mode of the vehicle interior is described in detail with reference to FIG. 7.

FIG. 7 is an operation diagram of a heat pump system for a vehicle according to an embodiment of the present disclosure, for cooling a battery module in the cooling mode of the vehicle interior.

Referring to FIG. 7, the coolant may circulate along the first line 2 by the operation of a water pump (not shown). The coolant may circulate along the second line 4 by the operation of a water pump (not shown).

In other words, the coolant having passed through the electrical component 3 may be supplied to the chiller 20 along the first line 2, and the coolant having passed through the battery module 5 may be supplied to the chiller 20 along the second line 4.

In the heat pump system. respective components may operate in order to cool the vehicle interior. Accordingly, the refrigerant may circulate along the refrigerant line 11.

The portion of the refrigerant line 11 connecting the compressor 10 and the first heat-exchanger 13, and the portion of the refrigerant line 11 connecting the first heat-exchanger 13 and the second heat-exchanger 14 may be closed by the first valve 18.

The portion of the refrigerant line 11 connecting the second end of the first connection line 21 and the first end of the fifth connection line 61 may be opened by the second valve 19.

The portion of the refrigerant line 11 connecting the second end of the third connection line 41 to the second heat-exchanger 14 may be opened.

The portion of the refrigerant line 11 connecting the second heat-exchanger 14 to the third heat-exchanger 16 may be opened by the first expansion valve 15.

In addition, the portion of the refrigerant line 11 connecting the third heat-exchanger 16 to the compressor 10 may be opened by the third expansion valve 25.

The third expansion valve 25 may allow the introduced refrigerant to flow without expansion.

The first connection line 21 may be opened by the second expansion valve 23, for cooling of the electrical component 3 and the battery module 5.

Accordingly, the coolant having passed through the battery module 5 may be supplied to the chiller 20 along the second line 4.

The second expansion valve 23 may expand the refrigerant introduced through the first connection line 21 and allow the expanded refrigerant to flow into the chiller 20 so that the battery module 5 may be cooled by using the coolant heat-exchanged with the refrigerant in the chiller 20.

Accordingly, the coolant having passed through the chiller 20 may be cooled through heat-exchange with the expanded refrigerant supplied to the chiller 20.

In other words, the coolant passing through the chiller 20 may be cooled through heat-exchange with the expanded refrigerant supplied to the chiller 20. The coolant cooled in the chiller 20 may be supplied to the battery module 5 along the second line 4. Accordingly, the battery module 5 may be efficiently cooled by the coolant cooled in the chiller 20.

The second connection line 31 may be closed by the fourth expansion valve 33. The third connection line 41 may be opened by the third valve 43.

In addition, the fourth connection line 51 may be closed by the fifth expansion valve 53. The fifth connection line 61 may be closed by the fourth valve 63. In addition, the sixth connection line 71 may be closed by the sixth expansion valve 73.

In such a state, the refrigerant discharged from the compressor 10 may flow along the third connection line 41 without passing through the first heat-exchanger 13.

In other words, the refrigerant discharged from the compressor 10 may flow along the third connection line 41, and may be introduced into the second heat-exchanger 14 along the portion of the refrigerant line 11 connected to the second heat-exchanger 14.

The second heat-exchanger 14 may primarily cool the refrigerant by using the air introduced from the outside.

The refrigerant discharged from the second heat-exchanger may be introduced into the internal heat-exchanger 17a along the refrigerant line 11. The internal heat-exchanger 17a may perform additionally cooling the refrigerant, by heat-exchanging the refrigerant supplied from the second heat-exchanger 14, and the refrigerant respectively supplied from the third heat-exchanger 16 and the chiller 20, with each other.

A partial refrigerant among the refrigerant discharged from the internal heat-exchanger 17a may be introduced into the chiller 20 along the first connection line 21.

The refrigerant introduced into the chiller 20 may be heat-exchanged with the coolant supplied through the second line 4, may pass through the internal heat-exchanger 17a and the accumulator 17 through the refrigerant line 11 connected to the first connection line 21, and then may be introduced into the compressor 10.

In addition, a remaining refrigerant among the refrigerant discharged from the internal heat-exchanger 17a may be introduced into the first expansion valve 15 along the refrigerant line 11 so as to cool the vehicle interior.

The first expansion valve 15 may expand the introduced through the refrigerant line 11 and allow the expanded refrigerant to flow into the third heat-exchanger 16.

The refrigerant having passed through the third heat-exchanger 16 may sequentially pass through the internal heat-exchanger 17a, the accumulator 17, the compressor 10 along the refrigerant line 11.

In other words, the refrigerant discharged from the chiller 20, and the refrigerant discharged from the third heat-exchanger 16 may pass through the internal heat-exchanger 17a and the accumulator 17 along the refrigerant line 11, to be then supplied to the compressor 10.

The air introduced into the HVAC module 12 may be cooled by the low-temperature refrigerant introduced into the third heat-exchanger 16 while passing through the third heat-exchanger 16.

The cooled air may cool the vehicle interior by being directly introduced into the vehicle interior.

The refrigerant having an increased cooling level while sequentially passing through the second heat-exchanger 14 the internal heat-exchanger 17a may be expanded and supplied to the third heat-exchanger 16.

In other words, in an embodiment of the present disclosure, the second heat-exchanger 14 may cool the refrigerant through heat-exchange with the air, and the internal heat-exchanger 17a may additionally cool the refrigerant through heat-exchange with the low-temperature refrigerant.

By such an operation, the heat pump system may more efficiently cool the R744 refrigerant fomred of carbon dioxide, thereby securing a larger phase change heat transfer section of the refrigerant.

In addition, as the refrigerant having secured the larger phase change heat transfer section is evaporated in the third heat-exchanger 16, the temperature of the air passing through the third heat-exchanger 16 may be further lowered, thereby improving the cooling performance and efficiency.

While repeatedly performing the above-described processes, in the cooling mode of the vehicle interior, the refrigerant may cool the vehicle interior and at the same time, cool the coolant through heat-exchange while passing through the chiller 20.

A low-temperature coolant cooled in the chiller 20 may be introduced into the battery module 5 through the second line 4. Accordingly, the battery module 5 may be efficiently cooled by the supplied low-temperature coolant.

Therefore, as described above, when a heat pump system for a vehicle according to an embodiment of the present disclosure is applied, cooling or heating of the vehicle interior may be performed by using a natural refrigerant, thereby enabling compliance with environmental regulations, and improving the overall marketability of the vehicle.

In addition, according to the present disclosure, by operating in both a supercritical region and a subcritical region in which the pressure and/or temperature of the refrigerant is higher than the critical pressure and/or temperature at the time of cooling and heating the vehicle interior, by applying the R744 refrigerant, which is a natural refrigerant utilizing carbon dioxide, the cooling and heating performance can be maximized.

In addition, according to the present disclosure, by efficiently adjusting the temperature of the battery module 5 depending on the mode of the vehicle by using the single chiller 20 where the coolant and the refrigerant are heat-exchanged with each other, streamlining and simplification of the system may be achieved.

In addition, according to the present disclosure, by efficiently adjusting the temperature of the battery module 5, the optimal performance of the battery module 5 may be obtained, and the overall travel distance of the vehicle may be increased through the efficient management of the battery module 5.

In addition, according to the present disclosure, even if the external temperature is low, and the heat generated from the electrical component 3 and the battery module 5 is not sufficient, the heating of the vehicle interior may be performed by using the high-temperature refrigerant compressed in the compressor 10.

In addition, according to the present disclosure, by heating the battery module 5 by using the coolant heated increased through heat-exchange with the refrigerant, a separate coolant heater for heating of the battery module 5 may be removed, and the power consumption for increasing the temperature of the battery module 5 can be minimized.

In addition, according to the present disclosure, through streamlining of an entire system, it is possible to reduce manufacturing cost and weight and improve space utilization.

While this disclosure has been described in connection with what is presently considered to be practical embodiments of the present disclosure, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

2, 4: first and second lines
3: electrical component
5: battery module
10: compressor
11: refrigerant line
12: HVAC module
13, 14, 16: first, second, and third heat-exchangers
15: first expansion valve
17: accumulator
17a: internal heat-exchanger
18, 19: first and second valves
20: chiller
21: first connection line
23: second expansion valve
25: third expansion valve
31: second connection line
33: fourth expansion valve
41: third connection line
43: third valve
51: fourth connection line
53: fifth expansion valve
61: fifth connection line
63: fourth valve
71: sixth connection line
73: sixth expansion valve

What is claimed is:

1. A heat pump system for a vehicle, the heat pump system comprising:
a compressor, a first heat-exchanger, a second heat-exchanger, a first expansion valve, and a third heat-exchanger, which are connected through a refrigerant line to circulate a refrigerant;
a chiller connected to the refrigerant line through a first connection line, the chiller configured to adjust a temperature of a coolant by exchanging heat between the refrigerant and the coolant;
a second expansion valve provided on the first connection line;
a third expansion valve provided on the refrigerant line between the third heat-exchanger and the compressor;
a second connection line including:
a first end connected to the refrigerant line between the first heat-exchanger and the second heat-exchanger, and
a second end connected to the refrigerant line between the second heat-exchanger and the third heat-exchanger;
a fourth expansion valve provided on the second connection line;
a third connection line including:
a first end connected to the refrigerant line between the compressor and the first heat-exchanger, and
a second end connected to the refrigerant line between the first heat-exchanger and the second heat-exchanger; and
a fourth connection line including:
a first end connected to the refrigerant line between the second heat-exchanger and the third heat-exchanger, and
a second end connected to the refrigerant line between the third heat-exchanger and the third expansion valve.

2. The heat pump system of claim 1, further comprising:
a first valve provided on the refrigerant line between the first heat-exchanger and the second heat-exchanger;
a second valve provided on the refrigerant line between the third expansion valve and the compressor;
a third valve provided on the third connection line; and
a fifth expansion valve provided on the fourth connection line.

3. The heat pump system of claim 2, further comprising:
a fifth connection line including:
a first end connected to the refrigerant line between the third expansion valve and the compressor, and
a second end connected to the refrigerant line between the first heat-exchanger and the second heat-exchanger;
a fourth valve provided on the fifth connection line;
a sixth connection line including:
a first end connected to the first connection line between the second expansion valve and the chiller, and
a second end connected to the third connection line; and
a sixth expansion valve provided on the sixth connection line.

4. The heat pump system of claim 3, further comprising:
an accumulator provided on the refrigerant line between the third heat-exchanger and the compressor; and
an internal heat-exchanger provided inside the accumulator, and configured to exchange heat between the refrigerant supplied from the second heat-exchanger and the refrigerant supplied from the third heat-exchanger,
wherein the internal heat-exchanger is configured to supply the refrigerant having a higher temperature, among the heat-exchanged refrigerant, to the third heat-exchanger.

5. The heat pump system of claim 4, wherein, when a battery module is to be heated:
a portion of the refrigerant line connecting the compressor and the first heat-exchanger, and a portion of the refrigerant line connecting the first heat-exchanger and the second heat-exchanger are configured to be closed by the first valve;
a portion of the refrigerant line connecting the first end of the fifth connection line and the compressor is configured to be opened;
a portion of the refrigerant line connected to the second heat-exchanger is configured to be opened so that the first end of the fourth connection line and the second end of the fifth connection line are connected;
a portion of the refrigerant line connecting a second end of the first connection line and the second end of the fourth connection line is configured to be opened by the third expansion valve;
a portion of the refrigerant line connecting the second end of the first connection line and the first end of the fifth connection line is configured to be closed by the second valve;
a portion of the first connection line connecting the first end of the sixth connection line and the chiller is configured to be opened;
a remaining portion of the first connection line connecting the refrigerant line and the sixth connection line at an upstream end of the chiller is configured to be closed by the second expansion valve;
the second connection line is configured to be closed by the fourth expansion valve;
a portion of the third connection line is configured to be opened so that a portion of the refrigerant line connected to the compressor and the sixth connection line are connected;
a remaining portion of the third connection line is configured to be closed by the third valve;
the fourth connection line is configured to be opened by the fifth expansion valve;
the fifth connection line is configured to be opened by the fourth valve; and
the sixth connection line is configured to be opened by the sixth expansion valve.

6. The heat pump system of claim 5, wherein:
the third expansion valve and the sixth expansion valve are configured to allow the refrigerant to flow without expansion;
the fifth expansion valve is configured to allow the refrigerant to flow in an expanded state;
the refrigerant discharged from the compressor flows sequentially through a portion of the third connection line, the sixth connection line, and a portion of the first connection line, and is introduced into the chiller;
the refrigerant having passed through the chiller flows through a portion of the first connection line, the fourth connection line, and the opened portion of the refrigerant lines, and is introduced into the second heat-exchanger; and
the refrigerant discharged from the second heat-exchanger flows through the internal heat-exchanger and the accumulator via a portion of the refrigerant lines and the fifth connection line, and is supplied to the compressor.

7. The heat pump system of claim 4, wherein, in a hot gas heating mode of a vehicle interior;
a portion of the refrigerant line connecting a first end of the first connection line to the second end of the second connection line is configured to be closed by the first expansion valve;
a portion of the refrigerant line connecting the first end of the second connection line and the second end of the fifth connection line is configured to be closed by the first valve;
a portion of the refrigerant line connecting the second end of the second connection line to a second end of the first connection line by passing through the third heat-exchanger is configured to be opened by the third expansion valve;
a portion of the refrigerant line connecting the second end of the first connection line and the first end of the fifth connection line is configured to be opened by the second valve;
a portion of the refrigerant line connecting the second end of the fifth connection line to the first end of the first connection line via the second heat-exchanger is configured to be closed;
a portion of the first connection line connecting the first end of the sixth connection line and the chiller is configured to be opened;
a remaining portion of the first connection line connecting the refrigerant line and the sixth connection line on an upstream end of the chiller is configured to be closed by the second expansion valve;
the second connection line is configured to be opened by the fourth expansion valve;
a portion of the third connection line is configured to be opened so that a portion of the refrigerant line connected to the compressor and the sixth connection line are connected;
a remaining portion of the third connection line is configured to be closed by the third valve;
the fourth connection line is configured to be closed by the fifth expansion valve;
the fifth connection line is configured to be closed by the fourth valve; and
the sixth connection line is configured to be opened by the sixth expansion valve.

8. The heat pump system of claim 7, wherein:
the third expansion valve and the sixth expansion valve are configured to allow the refrigerant to flow in an expanded state;
the fourth expansion valve is configured to allow the refrigerant to flow without expansion;
a partial refrigerant among the refrigerant discharged from the compressor flows through the refrigerant line, and is introduced into the first heat-exchanger;
the refrigerant having passed through the first heat-exchanger flows through the second connection line and the opened refrigerant line, and is introduced into the third heat-exchanger;
a remaining refrigerant among the refrigerant discharged from the compressor flows through a portion of the third connection line, the sixth connection line, and the opened first connection line, and is introduced into the chiller; and
the refrigerant having passed through the third expansion valve from the third heat-exchanger, and the refrigerant discharged from the chiller pass through the internal heat-exchanger and the accumulator along a portion of the refrigerant line, and is supplied to the compressor.

9. The heat pump system of claim 4, wherein, in a heating mode of a vehicle interior:
a portion of the refrigerant line connecting a first end of the first connection line to the second end of the second connection line is configured to be closed by the first expansion valve;
a portion of the refrigerant line connecting the first end of the second connection line and the second end of the fifth connection line is configured to be closed by the first valve;
a portion of the refrigerant line connecting the second end of the fourth connection line and a second end of the first connection line is configured to be closed by the third expansion valve;
a portion of the refrigerant line connecting the second end of the first connection line and the first end of the fifth connection line is configured to be opened by the second valve;
the first connection line is configured to be opened by the second expansion valve;
the second connection line is configured to be opened by the fourth expansion valve;
the third connection line is configured to be closed by the third valve;
the fourth connection line is configured to be opened by the fifth expansion valve;
the fifth connection line is configured to be opened by the fourth valve; and
the sixth connection line is configured to be closed by the sixth expansion valve.

10. The heat pump system of claim 9, wherein:
the second expansion valve and the fourth expansion valve are configured to allow the refrigerant to flow without expansion;
the fifth expansion valve is configured to allow the refrigerant to flow in an expanded state so that the refrigerant expanded by the fifth expansion valve is supplied to the second heat-exchanger, the internal heat-exchanger, and the chiller;
a partial refrigerant among the refrigerant introduced into the fourth connection line from the third heat-exchanger is introduced into the second heat-exchanger; and
a remaining refrigerant among the refrigerant introduced into the fourth connection line from the third heat-exchanger is introduced into the internal heat-exchanger.

11. The heat pump system of claim 9, wherein:
a partial refrigerant among the refrigerant discharged from the fifth expansion valve flows through the internal heat-exchanger along the refrigerant line, and is introduced into the chiller; and
the refrigerant discharged from the second heat-exchanger and the chiller flows through the internal heat-exchanger and the accumulator, and is supplied to the compressor.

12. The heat pump system of claim 4, wherein, when heating of a battery module is required in a heating mode of a vehicle interior:
a portion of the refrigerant line connecting a first end of the first connection line to the second end of the second connection line, and a portion of the refrigerant line connecting the first end of the fourth connection line to the first end of the first connection line are configured to be closed by the first expansion valve;
a portion of the refrigerant line connecting the first end of the second connection line and the second end of the fifth connection line is configured to be closed by the first valve;
a portion of the refrigerant line connecting the second end of the second connection line to the second end of the first connection line by passing through the third heat-exchanger is configured to be opened by the third expansion valve;
a portion of the refrigerant line connecting the second end of the first connection line and the first end of the fifth connection line is configured to be closed by the second valve;
a portion of the refrigerant line connected to the second heat-exchanger is configured to be opened so that the first end of the fourth connection line and the second end of the fifth connection line are connected;
a portion of the first connection line connecting the first end of the sixth connection line and the chiller is configured to be opened;
a remaining portion of the first connection line connecting the refrigerant line and the sixth connection line on an upstream end of the chiller is configured to be closed by the second expansion valve;
the second connection line is configured to be opened by the fourth expansion valve;
a portion of the third connection line is configured to be opened so that a portion of the refrigerant line connected to the compressor and the sixth connection line are connected;
a remaining portion of the third connection line is configured to be closed by the third valve;
the fourth connection line is configured to be opened by the fifth expansion valve;
the fifth connection line is configured to be opened by the fourth valve; and
the sixth connection line is configured to be opened by the sixth expansion valve.

13. The heat pump system of claim 12, wherein:
the third expansion valve, the fourth expansion valve, and the sixth expansion valve are configured to allow the refrigerant to flow without expansion;
the fifth expansion valve is configured to allow the refrigerant to flow in an expanded state;
a partial refrigerant among the refrigerant discharged from the compressor is introduced into the first heat-exchanger along the refrigerant line;
the refrigerant having passed through the first heat-exchanger is introduced into the third heat-exchanger along the second connection line and the opened refrigerant line;
a remaining refrigerant among the refrigerant discharged from the compressor is introduced into the chiller along a portion of the third connection line, the sixth connection line, and the opened first connection line;
the refrigerant having passed through the third heat-exchanger, and the refrigerant having passed through the third expansion valve from the chiller are introduced into the second heat-exchanger along a portion of the refrigerant line and the fourth connection line; and
the refrigerant discharged from the second heat-exchanger passes through the internal heat-exchanger and the accumulator along the opened portion of the refrigerant lines and the fifth connection line, to be supplied to the compressor.

14. The heat pump system of claim 4, wherein, in a heating-and-dehumidifying mode of a vehicle interior:
a portion of the refrigerant line connecting a first end of the first connection line and the second end of the second connection line is configured to be closed by the first expansion valve;
a portion of the refrigerant line connecting the first end of the second connection line and the second heat-exchanger is configured to be closed by the first valve;
a portion of the refrigerant line connecting the third heat-exchanger and the accumulator is configured to be opened by the second valve and the third expansion valve;
a portion of the refrigerant line connecting the second heat-exchanger to the internal heat-exchanger and the first end of the first connection line is configured to be closed;
the first connection line is configured to be closed by the second expansion valve;
the second connection line is configured to be opened by the fourth expansion valve;
the third connection line is configured to be closed by the third valve;
the fourth connection line is configured to be closed by the fifth expansion valve;
the fifth connection line is configured to be closed by the fourth valve; and
the sixth connection line is configured to be closed by the sixth expansion valve.

15. The heat pump system of claim 14, wherein:
the third expansion valve is configured to allow the refrigerant to flow without expansion;
the fourth expansion valve is configured to allow the refrigerant introduced through the second connection line from the first heat-exchanger to flow in an expanded state;
the refrigerant discharged from the compressor is introduced into the first heat-exchanger along a portion of the refrigerant line;
the refrigerant having passed through the first heat-exchanger is introduced into the third heat-exchanger along the second connection line and the opened refrigerant line; and
the refrigerant having passed through the third expansion valve from the third heat-exchanger passes through the internal heat-exchanger and the accumulator along the opened portion of the refrigerant line, to be t supplied to the compressor.

16. The heat pump system of claim 4, wherein, when cooling of a battery module is required in a cooling mode of a vehicle interior:
a portion of the refrigerant line connecting the compressor and the first heat-exchanger, and a portion of the refrigerant line connecting the first heat-exchanger and the second heat-exchanger are configured to be closed by the first valve;
a portion of the refrigerant line connecting the second end of the third connection line to the second heat-exchanger is configured to be opened;
a portion of the refrigerant line connecting the second heat-exchanger to the third heat-exchanger is configured to be opened by the first expansion valve;
a portion of the refrigerant line connecting the third heat-exchanger to the compressor is configured to be opened by the third expansion valve;
a portion of the refrigerant line connecting a second end of the first connection line and the first end of the fifth connection line is configured to be opened by the second valve;
the first connection line is configured to be opened by the second expansion valve;
the second connection line is configured to be closed by the fourth expansion valve;
the third connection line is configured to be opened by the third valve;
the fourth connection line is configured to be closed by the fifth expansion valve;
the fifth connection line is configured to be closed by the fourth valve; and
the sixth connection line is configured to be closed by the sixth expansion valve.

17. The heat pump system of claim 16, wherein:
the first expansion valve is configured to allow the refrigerant to flow in an expanded state;
the second expansion valve is configured to allow the refrigerant to flow in an expanded state so that the battery module is cooled by using the coolant heat-exchanged with the refrigerant in the chiller;
the third expansion valve is configured to allow the refrigerant to flow without expansion;
the refrigerant discharged from the compressor passes through the second heat-exchanger along the third connection line and a portion of the refrigerant line, to be introduced into the internal heat-exchanger;
a partial refrigerant among the refrigerant discharged from the internal heat-exchanger is introduced into the chiller along the first connection line;
a remaining refrigerant among the refrigerant discharged from the internal heat-exchanger is introduced into the first expansion valve along the refrigerant line; and
the refrigerant discharged from the chiller, and the refrigerant discharged from the third heat-exchanger pass through the internal heat-exchanger and the accumulator along the refrigerant line, to be supplied to the compressor.

18. The heat pump system of claim 1, wherein the second heat-exchanger and the third heat-exchanger are configured to cool or evaporate the interiorly refrigerant.

19. The heat pump system of claim 1, wherein:
a first end of the first connection line is connected to the refrigerant line between the second heat-exchanger and the first expansion valve; and
a second end of the first connection line is connected to the refrigerant line between the third heat-exchanger and the compressor.

20. The heat pump system of claim 1, wherein:
the first heat-exchanger, the second heat-exchanger, and the third heat-exchanger are air-cooled gas coolers configured to exchange heat between the refrigerant and air; and
the chiller is a water-cooled gas cooler configured to exchange heat between the refrigerant and the coolant.
